(19) United States
(12) Patent Application Publication
(10) Pub. No.: US 2025/0355640 A1
(43) Pub. Date: Nov. 20, 2025

(54) SYSTEM AND METHOD FOR DESIGNING A PROGRAMMABLE SEQUENCER USING A NO CODE APPROACH

(71) Applicant: ITDA SEMICONDUCTOR CO., LTD., Hwaseong-si (KR)

(72) Inventors: Ingyu KIM, Hwaseong-si (KR); Hoyeon JEON, Seongnam-si (KR); Ahchan KIM, Hwaseong-si (KR)

(73) Assignee: ITDA SEMICONDUCTOR CO., LTD., Hwaseong-si (KR)

(21) Appl. No.: 19/194,881

(22) Filed: Apr. 30, 2025

(30) Foreign Application Priority Data
May 14, 2024 (KR) 10-2024-0063370

(51) Int. Cl. G06F 8/34

(52) U.S. Cl. CPC G06F 8/34

(57) ABSTRACT

A system and method for designing a programmable sequencer capable of modifying power up and power down sequences for power control in a power domain using a no-code approach. According to one embodiment, the system includes a memory to store at least one instruction, a component storage configured to store power component information and instruction component information, a code logic storage configured to store software code logic for generating executable code based on an instruction instance, and at least one processor configured to execute the stored instruction(s). The instruction(s) include operations for generating at least one power instance based on a power component, generating a first instruction instance based on an instruction component, determining a target power instance among the generated power instances and setting a value, and generating code including an instruction, a register address, and data based on the instruction instance, the target power instance, and the value.

### CROSS-REFERENCE TO RELATED APPLICATIONS

This application claims the benefit of priority to Korean Patent Application No. 10-2024-0063370, filed May 14, 2024, the entire content of which is incorporated herein by reference.

### TECHNICAL FIELD

The present disclosure relates to the design of a programmable sequencer for power control, and more particularly, to a system and method for designing a programmable sequencer, using a no-code approach, that is capable of changing a power up/down sequence for power control in a power domain.

### BACKGROUND

A system-on-chip (SoC) refers to a technology for integrating various function blocks—such as a central processing unit (CPU), a memory, an interface, a digital signal processing circuit, and an analog signal processing circuit-into a single semiconductor integrated circuit, or to an integrated circuit (IC) that has been integrated according to such a technology in order to implement a computer system or another electronic system. The SoC is evolving into a more complex system that includes various function blocks such as a processor, multimedia, graphics, an interface, and security.

In general, power and clock design are important in a system-on-chip. A system-on-chip requires a power management unit to properly manage power, and the power management unit includes a power controller that outputs power up and power down sequences for each power domain.

A conventional power controller has been designed as a fixed sequencer that outputs predetermined sequences based on a state machine. The state machine has the advantages of simplicity and speed, but has the disadvantage of limited flexibility because it only executes predetermined sequences.

Recently, as SoCs have become increasingly complex, the power up/down sequences for each power domain have also become more complicated, and as a result, when a SoC is designed and then fabbed out into an actual silicon chip, various abnormal cases may occur. When such abnormal cases occur, the power up/down sequence needs to be changed, but a state machine designed to operate as a fixed sequencer has a problem in that it cannot flexibly cope with various abnormal cases.

In recent years, there has been a growing trend toward the design of power controllers utilizing a microcontroller unit (MCU). The power controller is designed using Cortex-M, a commercially available microcontroller unit developed by ARM Holdings, but because commercial MCUs are expensive, assigning and deploying a separate power controller for each power domain significantly increases the cost of the system-on-chip device.

In light of this, the applicant of the present invention has developed a technology for implementing a power controller for power control in a power domain as a programmable sequencer capable of changing power up/down sequences, and filed it under Korean Patent Application No. 10-2023-0119063, titled “PROGRAMMABLE SEQUENCER, AND SYSTEM-ON CHIP DEVICE USING THE SAME”. To implement such a programmable sequencer, it is necessary to design the microcontroller unit during the system-on-chip design process to function as a programmable sequencer for controlling the power of the power domain.

The power and clock design process for a typical system-on-chip (SoC) may include a power/clock diagram drawing stage, a Verilog coding and scripting stage, a first documentation stage, UPF/SDC (Unified Power Format/Standard Design Constraint) file generation stage, an implementation layout design stage, a second documentation stage, DFT (Design for Testability) controller insertion stage, a hardware system interpretation stage, and a software optimization stage.

The power/clock diagram drawing stage visually represents the power and clock structure, and creates a block diagram to depict the power domains and clock trees. In the power/clock diagram drawing stage, the clock elements and their link relationships are simply illustrated in a diagram. The Verilog coding and scripting stage involves writing Verilog code and scripts used to define and implement the functionality of the SoC, thereby performing hardware design at the register transfer level (RTL). In other words, based on the outputs of the power/clock diagram drawing, the developer manually generates the register transfer level (RTL) code.

The first documentation stage is a phase in the early stages of the project where the design intent and structure are documented. In this phase, various types of documents are prepared, including requirement specifications needed by multiple stakeholders such as the verification team and software development team, architectural designs, and power/clock diagrams.

The UPF/SDC (Unified Power Format/Standard Design Constraint) file generation stage is a phase in which Unified Power Format (UPF) and Standard Design Constraint (SDC) files are created to control power management and timing constraints, thereby generating the necessary inputs for hardware synthesis.

The implementation layout design stage is the phase in which the layout and placement of the actual SoC chip are designed at the gate level. The second documentation stage is the phase where various documents are updated and supplemented to reflect changes in the design and implementation. The DFT (Design for Testability) controller insertion stage involves the design and integration of DFT controllers and logic circuits into the SoC for testing and debugging purposes. The hardware system interpretation stage is the phase in which the operation of the hardware is verified and interpreted through simulation and validation to ensure the accuracy and efficiency of the design, and the software optimization stage involves profiling and optimizing the software code executed on the SoC to enhance software performance.

Each stage of the design process for such an SoC involves various stakeholders who independently carry out the tasks associated with that stage, and the information required at each stage may differ significantly. Specifically, the information needed for the tasks in the earlier phases may vary from that required for the tasks in the later phases. As a result, the outputs of the initial design efforts by the workers in the earlier phases may reveal issues through simulation and validation in the later phases, necessitating a repetition of the earlier tasks to address these problems. Furthermore, if requirements or design objectives change during the course of the project, it may also be necessary to revisit and repeat the initial design work.

During the repetition of multiple stages, various stakeholders must reflect changes from different stages and perform similar tasks repeatedly, which results in significant time and resource consumption in the system-on-chip (SoC) design process.

### SUMMARY

An aspect to be accomplished by certain embodiments of the present invention is to provide a no-code programmable sequencer design system and method that automatically derives a register transfer level (RTL) code corresponding to a programmable sequencer that constitutes a power management unit by taking into account the settings required in the power design process of a SoC to solve the above problems.

An exemplary embodiment of the present disclosure may be implemented in various ways, including an apparatus (system), a method, a computer program stored in a computer-readable medium, or a computer-readable medium having a computer program stored thereon.

A no-code programmable sequencer design system according to an embodiment of the present invention includes a memory configured to store at least one instruction, a component storage having power component information and instruction component information stored thereon, a code logic storage configured to store a software code logic for generating a code based on an instruction instance, and at least one processor configured to execute the at least one instruction stored in the memory. The at least one instruction includes instructions for generating at least one power instance configuring a programmable sequencer based on a power component, generating a first instruction instance based on an instruction component, determining a target power instance of the first instruction instance from among one or more power instances and setting a value, and generating a code including an instruction, a register address, and data based on the first instruction instance, the target power instance, and the value.

Preferably, the programmable sequencer may be at least one of a root power manager and a domain power manager.

Preferably, the at least one instruction includes instructions for generating a second instruction instance based on an instruction component, determining a target power instance of the second instruction instance from among one or more power instances and setting a value, and setting an execution order between the first instruction instance and the second instruction instance.

More preferably, the power component may be at least one of a reset component, an isolation component, a switch control component, a retention component, an automatic power manager component, a reference clock gating component, a memory component, a handshake component, a clock link component, a P-channel handshake component, a user-defined output component, or a user-defined input component.

More preferably, the power component may be at least one of an inform register generation component, a timeout register generation component, an upper information transfer register generation component, an internal register storage component, an internal register control interrupt generation component, an external input control interrupt generation component, a timer generation component, or a domain power manager connection component.

Preferably, the instruction component may be at least one of a WRITE component for writing a specific value to a specific register field, a READWAIT component for waiting for a specific value to be input to a specific register field, a WAIT component for waiting for a predetermined time, an IF component for branching according to a condition, a GOTO component for moving to a specific location, or a CALL component for moving to a specific location and returning thereafter.

More preferably, the component storage further stores an auxiliary instruction component, and the auxiliary instruction component includes at least one of a LABEL component, a START component, and an END component.

More preferably, the instruction component and the auxiliary instruction component may each include a unique border shape.

More preferably, the LABEL component allows any two or more instruction components that are spaced apart from each other to be substantially connected, and at least one of a name and a color is assigned to the LABEL component for identification.

According to one embodiment of the present invention, a method for designing a programmable sequencer in a no-code approach is provided in a computer system including a component storage storing power component information and instruction component information, and a code logic storage storing a software code logic for generating a code based on an instruction instance. The method is executed by at least one processor and includes the stages of: (i) generating at least one power instance that constitutes a programmable sequencer based on a power component, (ii) generating a first instruction instance based on an instruction component, (iii) determining a target power instance of the first instruction instance from among one or more power instances and setting a value, and (iv) generating a code including an instruction, a register address, and data based on the first instruction instance, the target power instance, and the value.

Preferably, the programmable sequencer may be at least one of a root power manager and a domain power manager.

Preferably, the method further includes: generating a second instruction instance based on an instruction component, determining a target power instance of the second instruction instance from among one or more power instances and setting a value, and setting an execution order between the first instruction instance and the second instruction instance.

More preferably, the power component may be at least one of a reset component, an isolation component, a switch control component, a retention component, an automatic power manager component, a reference clock gating component, a memory component, a handshake component, a clock link component, a P-channel handshake component, a user-defined output component, or a user-defined input component.

More preferably, the power component may be at least one of an inform register generation component, a timeout register generation component, an upper information transfer register generation component, an internal register storage component, an internal register control interrupt generation component, an external input control interrupt generation component, a timer generation component, or a domain power manager connection component.

Preferably, the instruction component may be at least one of a WRITE component for writing a specific value to a specific register field, a READWAIT component for waiting for a specific value to be input to a specific register field, a WAIT component for waiting for a predetermined time, an IF component for branching according to a condition, a GOTO component for moving to a specific location, or a CALL component for moving to a specific location and returning thereafter.

More preferably, the component storage further stores an auxiliary instruction component, and the auxiliary instruction component includes at least one of a LABEL component, a START component, and an END component.

More preferably, the instruction component and the auxiliary instruction component may each include a unique border shape.

More preferably, the LABEL component allows any two or more instruction components that are spaced apart from each other to be substantially connected, and at least one of a name and a color is assigned to the LABEL component for identification.

A computer program is provided, which is stored on a computer-readable medium and configured to execute the aforementioned method according to an embodiment of the present invention.

According to various embodiments of the present invention, a programmable sequencer constituting a power management unit can be designed by taking into account settings required in a power design process of a system-on-chip.

According to various embodiments of the present invention, a hardware code corresponding to a programmable sequencer constituting a power management unit-namely, a register transfer level (RTL) code—can be automatically derived, thereby effectively improving the efficiency of the design process.

According to various embodiments of the present invention, an operator can derive a programmable sequencer constituting a power management unit into a hardware code (i.e., a register transfer level (RTL) code) using a no-code approach without requiring coding knowledge or clock process knowledge.

According to various embodiments of the present invention, a programmable sequencer can be designed by taking into account settings required throughout the entire power design process, thereby facilitating global optimization.

The effects of the present invention are not limited to the above-described effects, and other effects not explicitly mentioned will be readily understood by those skilled in the art from the scope of the claims.

### BRIEF DESCRIPTION OF THE DRAWINGS

Embodiments of the present invention will be described with reference to the accompanying drawings, in which similar reference numerals denote similar elements, but are not limited thereto.

FIG. 1 is a configuration diagram of a system-on-chip (SoC) to be designed according to some embodiments of the present disclosure.

FIG. 2 is a configuration diagram of the domain power manager of FIG. 1 according to some embodiments of the present disclosure.

FIG. 3 illustrates a power state transition diagram of a power domain according to some embodiments of the present disclosure.

FIG. 4 illustrates an example of a power up sequence and a power down sequence executed by the domain power manager according to some embodiments of the present disclosure.

FIG. 5 illustrates a programmable sequencer design system using a no-code approach according to some embodiments of the present disclosure.

FIG. 6 illustrates an example of a display screen of a programmable sequencer design system using a no-code approach according to some embodiments of the present disclosure.

FIG. 7 illustrates a diagram of a power management unit displayed in a design window according to some embodiments of the present disclosure.

FIG. 8 illustrates a diagram of a root power manager displayed in a design window according to some embodiments of the present disclosure.

FIG. 9 illustrates a diagram of a domain power manager displayed in a design window according to some embodiments of the present disclosure.

FIG. 10 illustrates an example execution process diagram of a programmable sequencer displayed in a design window according to some embodiments of the present disclosure.

FIG. 11 illustrates an example screen showing the target power instance setting of an arbitrary instruction instance according to some embodiments of the present disclosure.

FIG. 12 illustrates an operation flowchart of a method for designing a programmable sequencer using a no-code approach according to some embodiments of the present disclosure.

FIG. 13 illustrates an example computing device for performing the above-described methods and/or embodiments according to some embodiments of the present disclosure.

### DETAILED DESCRIPTION

The following detailed description of the embodiments of the present invention will be made with reference to the accompanying drawings. However, in the following description, specific details regarding widely known functions or configurations will be omitted to avoid unnecessarily obscuring the essence of the present invention.

In the accompanying drawings, the same reference numerals are assigned to identical or corresponding components. Furthermore, in the description of the following embodiments, the repetition of descriptions for identical or corresponding components may be omitted. However, the omission of descriptions regarding certain components does not imply that such components are not included in any embodiment.

The advantages and features of the embodiments disclosed in this specification, as well as methods for achieving them, will become apparent with reference to the embodiments described below in conjunction with the accompanying drawings. However, the present disclosure is not limited to the embodiments described below but may be implemented in various other forms, and the embodiments are merely provided to fully inform those skilled in the art of the scope of the invention.

The terms used in this specification will first be briefly explained, followed by a detailed description of the disclosed embodiments. The terms used in this specification have been selected as general terms that are currently in wide use, in consideration of their functions in the present invention, but may vary depending on the intent of those skilled in the art, legal precedents, or the emergence of new technologies. In addition, in certain cases, some terms may have been arbitrarily selected by the applicant, and in such cases, their meanings will be described in detail in the relevant portions of the specification. Therefore, the terms used in the present invention should not be interpreted merely by their literal expressions, but should be defined based on their intended meanings and the overall context of the present invention.

In this specification, a singular expression shall be understood to include the plural unless clearly indicated otherwise by the context. Likewise, a plural expression shall be understood to include the singular unless clearly indicated otherwise by the context. Throughout the specification, when it is stated that a part includes a certain component, it is to be understood that, unless expressly stated otherwise, it does not exclude the inclusion of other components.

In the present disclosure, terms such as “include,” “including,” “comprise,” and “comprising” may indicate the presence of features, steps, actions, elements, and/or components, but do not preclude the addition of one or more other functions, steps, actions, elements, components, and/or combinations thereof.

In the present disclosure, when a specific component is referred to as being “coupled,” “combined,” “connected,” “associated,” or “reacting” with any other component, it should be understood that the specific component may be directly coupled, combined, connected, associated with, or reactive to the other component, but is not limited thereto. For example, one or more intermediate components may exist between the specific component and another component. Additionally, the term “and/or” in the present disclosure may include each of the listed items individually or at least some combination of one or more of the listed items.

In the present disclosure, terms such as “first,” “second,” and the like are used merely to distinguish one component from another and are not intended to limit the components described. For example, a “first” component may refer to an element that is identical or similar in form to a “second” component.

In various embodiments of the present invention, the term “power component” may refer to tools that can be used in the design of a programmable sequencer. Power components applicable to the design of a domain power manager may include a reset component, an isolation component, a switch control component, a retention component, an automatic power manager component, a reference clock gating component, a memory component, a handshake component, a clock link component, a P-channel handshake component, a user-defined output component, and a user-defined input component.

Power components applicable to the design of a root power manager may include an inform register generation component, a timeout register generation component, an upper information transfer register generation component, an internal register storage component, an internal register control interrupt generation component, an external input control interrupt generation component, a timer generation component, and a domain power manager connection component.

In various embodiments of the present invention, the term “power instance” may refer to a power component added to the design window through user manipulation. That is, a power instance may be a power component included in the design of a programmable sequencer. When a user drags and drops a power component icon from the power component window into the design window area, a power instance corresponding to that component may be created. Once the power instance is created, a register corresponding to that power instance may be automatically generated. The field values constituting the register created for each power instance may be preset or may be changed by user input. The programmable sequencer may include multiple power instances for each type of power component. A power instance created based on a reset component is referred to as a reset instance; a power instance created based on an isolation component is referred to as an isolation instance; a power instance created based on a switch control component is referred to as a switch control instance; and a power instance created based on a retention component is referred to as a retention instance. In addition, individual power instances may be created based on each power component. When a power instance is created, the register field values assigned to that instance may be automatically generated. Furthermore, hardware code may be generated based on the register field values of the power instance.

In various embodiments of the present invention, the term “power element” refers to a module implemented in hardware code based on a completed power instance, which may be used to configure the programmable sequencer.

In summary, a power component serves as the material for designing the programmable sequencer, a power instance is a node included in the design of each programmable sequencer, and a power element is a module operable within the programmable sequencer, implemented in hardware code based on a completed power instance.

In various embodiments of the present invention, the term “instruction component” refers to tools that can be used in designing the operation of power elements that constitute the programmable sequencer. Instruction components may include a WRITE component for writing a specific value to a specific register field, a READWAIT component for waiting for a specific value to be input into a specific register field, a WAIT component for waiting for a certain period of time, an IF component for branching based on a condition, a GOTO component for moving to a specific location, a CALL component for moving to a specific location and returning, a LABEL component, a START component, and an END component.

The term “instruction instance” may refer to an instruction component added to the design window through user manipulation. An instruction instance may have a power instance and a value set. The instruction is determined based on the instruction instance, the register field address is determined based on the power instance, and the data is determined based on the value. The determined instruction, register field address, and data may be stored as binary code in memory.

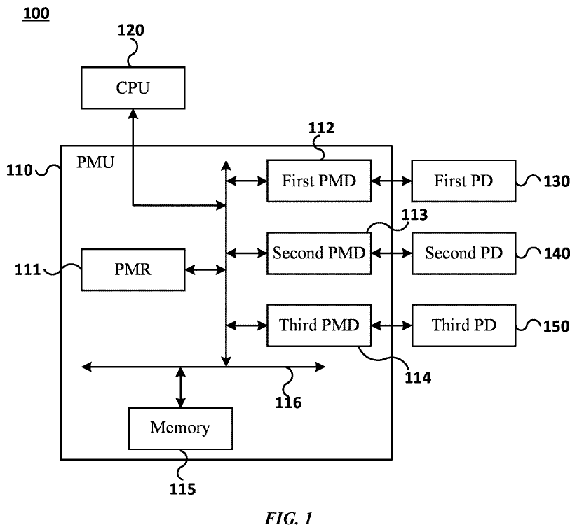

FIG. 1 is a configuration diagram of a system-on-chip (SoC) to be designed according to some embodiments of the present disclosure. The SoC device 100 includes a complete product and system integrated into a single integrated circuit, and may be implemented as a chip, a module, or a system.

The SoC device 100 includes a power management unit (PMU) 110, a central processing unit (CPU) 120 for controlling the power management unit 110 by software, and at least one power domain (PD) 130, 140, and 150. The central processing unit 120 may control the power management unit 110 and may be one of the power domains included in the SoC device. That is, the central processing unit 120 and the first power domain 130 may be the same component.

The power management unit 110 may provide a power up/down sequence corresponding respectively to power domains 130, 140, and 150. Each of the power domains 130, 140, and 150 may transition to a power up state or a power down state by processing the power up/down sequence. The SoC device may include at least one power management unit 110.

The power domains include a core domain including the central processing unit (CPU) 120, a memory domain including a memory subsystem such as main memory or cache memory, a graphics and video domain including multimedia elements such as a graphics processing unit or a video encoding/decoding device, and an input/output domain including I/O interface elements for external communication. Each of the power domains may include a lower sub power domain.

The power management unit 110 includes at least one domain power manager (PMD) 112, 113, and 114 corresponding to each of the power domains 130, 140, and 150 and controlling the corresponding power domains, a root power manager (PMR) 111 for managing the domain power managers 112, 113, and 114, and a memory 115 for storing a program that operates the root power manager 111 and the domain power managers 112, 113, and 114. The domain power managers 112, 113, and 114, the root power manager 111, and the memory 115 are interconnected by an internal bus 116. The program stored in the memory 115 includes instructions and data.

The root power manager 111 may receive a system power up/down command from the central processing unit (CPU) 120. The system power up/down command may include a command for powering up or down the system-on-chip device or a command for powering up or down a subsystem including at least one power domain. The power up/down command of the system-on-chip device and the power up/down command of the subsystem are collectively referred to as a system power up/down command. During booting, the root power manager 111 may operate at least one domain power manager 112, 113, and 114 based on instructions and data for executing the booting process of the system-on-chip device 100. In addition, when the system power up/down command is received from the central processing unit 120, the root power manager 111 may operate at least one domain power managers 112, 113, and 114 based on instructions and data for executing the corresponding command to power on or off the system-on-chip device 100 or a subsystem composed of multiple power domains.

When a domain power up/down command to control power in a power domain is received from the central processing unit (CPU) 120, at least one of the domain power managers 112, 113, and 114 may execute power up/down sequence control in the corresponding power domain based on instructions and data for executing the command.

The first domain power manager 112 outputs a power control signal to the first power domain 130 and executes a power up/down sequence; the second domain power manager 113 outputs a power control signal to the second power domain 140 and executes a power up/down sequence; and the third domain power manager 114 outputs a power control signal to the third power domain 150 and executes a power up/down sequence. Accordingly, since separate domain power managers 112, 113, and 114 are respectively assigned to power domains 130, 140, and 150 to independently perform power control in parallel, efficient and rapid processing is enabled.

The root power manager 111, the first domain power manager 112, the second domain power manager 113, and the third domain power manager 114 may each be implemented as a programmable sequencer.

The memory 115 stores instructions and data for the root power manager 111 to execute the system power up/down command in binary code, and stores instructions and data for each of the domain power managers 112, 113, and 114 to execute the domain power up/down command in binary code.

Although FIG. 1 illustrates a SoC device including three power domains and three domain power managers, the number of power domains may be designed differently according to the complexity of the SoC device, and the number of domain power managers may vary depending on the number of power domains. The root power manager 111 and each of the domain power managers 112, 113, and 114 may be programmable sequencers implemented as a microcontroller unit (MCU).

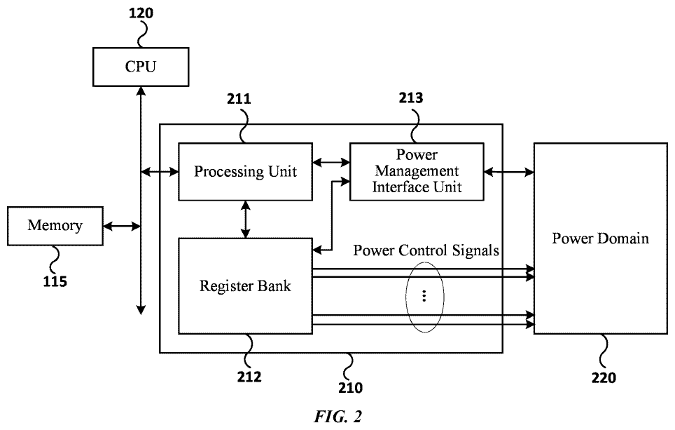

FIG. 2 is a configuration diagram of the domain power manager of FIG. 1 according to some embodiments of the present disclosure. The domain power manager 210 may be one example of a programmable sequencer.

The domain power manager 210 transmits power control signals to the power domain 220 and executes the power up/down sequence of the power domain 220 to transition between a power up state and a power down state. The power control signals for executing the power up/down sequence may include a reset signal, an isolation signal, a switch control signal, and a retention signal. These power control signals may be added, removed, or modified according to the specification of the power domain 220.

The domain power manager 210 of FIG. 2 may be one of the first domain power manager 112, the second domain power manager 113, and the third domain power manager 114 of FIG. 1. The power domain 220 of FIG. 2 may be one of the power domains 130, 140, and 150 of FIG. 1. When designing a domain power manager, a binary code of a program including instructions and data to be executed by the domain power manager 210 is stored in the memory 115, and the central processing unit (CPU) 120 may modify the program stored in the memory 115.

The central processing unit (CPU) 120 outputs a domain power up/down command to the domain power manager 210 to control the power domain 220. When the domain power up/down command is received, the domain power manager 210 executes a power up/down sequence by transmitting power control signals to the corresponding power domain 220. As a result, the power domain 220 transitions to either a power up state or a power down state.

The domain power manager 210 includes a processing unit 211 that receives a domain power up/down command related to power control of the power domain 220 from the central processing unit (CPU) 120, accesses the memory 115 in which instructions for executing the command are stored, and executes the instructions stored in the memory 115, and a register bank 212 that, by the operation of the processing unit 211, changes at least one field value to transmit power control signals to the power domain 220. The processing unit 211 includes a plurality of power elements, and each of the power elements may correspond to one of the power control signals.

The processing unit 211 may include at least one of: a power element for sending a reset signal to the power domain 220; a power element for sending an isolation signal to the power domain 220; a power element for sending a switch control signal to the power domain 220; a power element for sending a retention signal to the power domain 220; a power element for automatically executing power up/down in response to a hardware trigger signal; a power element for gating a reference clock supplied to the power domain 220; a power element for generating a power control signal in a memory of the power domain 220; a power element for generating a handshake control signal with the power domain 220; a power element for generating a link control signal with a clock management unit; a power element for generating a P-channel handshake control signal with the power domain 220; a power element for generating a user-defined output signal in the power domain 220; and a power element for generating a user-defined input signal in the power domain 220. The power elements constituting the processing unit 211 may be configured by generating power instances and generating hardware code based on the power instances in the design system of the present invention.

The register bank 212 includes a plurality of register fields corresponding to the power elements constituting the processing unit 211. A power element responsible for transmitting and receiving a power control signal with the power domain 220 may change the value of the corresponding register field, and the value recorded in the register field is sent to the power domain 220 as the corresponding power control signal. For example, a power element for sending a reset signal may change the value of the register field corresponding to the reset signal in the register bank 212 to 0 or 1, which is then transmitted to the reset port of the power domain 220. Likewise, a power element for sending an isolation signal may change the value of the register field corresponding to the isolation signal in the register bank 212 to 0 or 1, which is then transmitted to the isolation port of the power domain 220; similarly, power elements corresponding to a switch control signal or a retention signal may respectively change the value of the register field corresponding to the switch control signal or the retention signal in the register bank 212 to 0 or 1, which are then transmitted to the switch control port or the retention port of the power domain 220. To operate the processing unit 211, the memory 115 may further store a register field address to be executed together with the instruction and data.

The instructions stored in the memory 115 include an instruction to write 0 to a specific register field of the register bank 212 and an instruction to write 1 to a specific register field of the register bank 212. The processing unit 211 executes the instruction to change the specific register field value of the register bank 212 to 0 or 1. Then, the value of the corresponding power control signal is set to 0 or 1 and transmitted to the power domain 220.

The domain power manager 210 may further include a power management interface unit 213 that receives a signal from the power domain 220 and transmits it to at least one of the processing unit 211 and the register bank 212. Several of the power control signals are handshake-based signals. For example, after transmitting a power switch enable signal, it is necessary to wait until a corresponding feedback signal is received. In this case, the feedback signal output from the power domain 220 is stored in a specific register field of the register bank 212 through the power management interface unit 213, and the processing unit 211 waits until that register field is set to the specific value. The memory 115 may store an instruction to wait until a specific register field value of the register bank 212 becomes 0, and another instruction to wait until it becomes 1.

Also, among the power control signals, after transmitting a certain signal, the next operation may need to be performed after waiting for a predetermined period of time or longer. For example, when the power domain 220 is reset-released, it is necessary to wait until the power domain 220 completes the reset and becomes operational.

To this end, the instruction stored in the memory 115 may include an instruction to wait for a specific number of cycles.

The waiting time information may be stored in a specific register field of the register bank 212, or a constant value input by the user may be stored in an internal register of the processing unit.

Also, the instruction stored in the memory 115 may include: an instruction to write the value of an internal register of the processing unit 211 to a specific register field of the register bank 212; an instruction to write the value of a specific register field of the register bank 212 to an internal register of the processing unit 211; and an instruction to write a user-input constant value to an internal register of the processing unit 211.

Also, the instructions stored in the memory 115 may include instructions for determining the execution order of the stored instructions, including instructions for jumping to a specific address, returning to a previous address, or branching to a specific address depending on the result of an instruction execution.

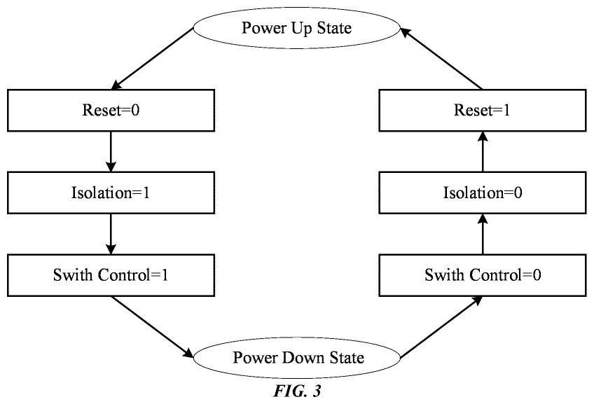

FIG. 3 illustrates a power state transition diagram of a power domain according to some embodiments of the present disclosure.

It is assumed that, when the power domain 220 is in a power up state, a transition of the reset signal from 1 to 0, the isolation signal from 0 to 1, and the switch control signal from 0 to 1 causes the power domain 220 to transition to a power down state. The power control signals that cause the power domain 220 to transition from a power up state to a power down state are referred to as a power down sequence. It is also assumed that, when the power domain 220 is in a power down state, a transition of the switch control signal from 1 to 0, the isolation signal from 1 to 0, and the reset signal from 0 to 1 causes the power domain 220 to transition to a power up state. The power control signals that cause the power domain 220 to transition from a power down state to a power up state are referred to as a power up sequence.

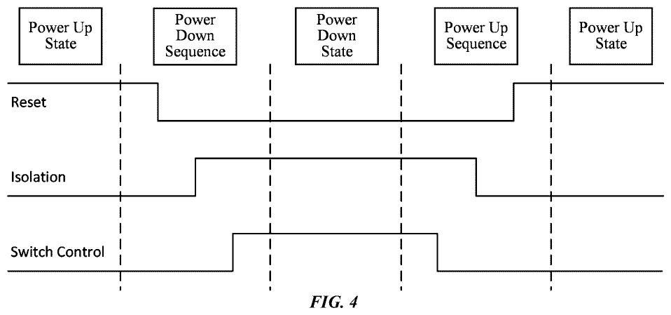

FIG. 4 illustrates an example of a power up sequence and a power down sequence executed by the domain power manager according to some embodiments of the present disclosure.

The domain power manager 210 executes a power up sequence and a power down sequence for the power domain 220, and the power domain 220 executes the power up sequence and the power down sequence to transition to a power up state and a power down state.

In a state where instructions for power control of the power domain 220 are stored in the memory 115 by the domain power manager 210, the central processing unit 120 transmits either a domain power up command or a domain power down command to the domain power manager 210.

When the domain power manager 210 receives a domain power down command from the central processing unit 120, it reads and executes instructions stored in the memory 115 for executing a power down sequence in the power domain 220. These instructions include an instruction for setting a specific register field value of the register bank 212 to 0 or 1, and by executing such instructions, the power down sequence may be performed in the power domain 220 as illustrated in FIG. 4.

Meanwhile, when the domain power manager 210 receives a domain power up command from the central processing unit 120, it reads and executes instructions stored in the memory 115 for executing a power up sequence in the power domain 220, and through this, the power up sequence may be performed in the power domain 220 as illustrated in FIG. 4.

When at least part of the power down sequence or the power up sequence is changed, the central processing unit 120 may modify the execution order and data of the instructions stored in the memory 115. Once the execution order and data of the instructions stored in the memory 115 are changed, the domain power manager 210 that receives a subsequent domain power up command or domain power down command executes the power up or power down sequence based on the modified execution order and data. In this manner, the domain power manager 210 functions as a programmable sequencer.

Similarly to the domain power manager described above, the root power manager may be implemented as a programmable sequencer. A program including instructions and data to be executed by the root power manager may be stored in the memory. The central processing unit may modify and store the program including the instructions and data in the memory. The central processing unit outputs a system power up or power down command to the root power manager. The system power up or power down command may include a command for the system-on-chip device or a command for an arbitrary subsystem composed of multiple power domains.

The memory stores instructions to be executed by the root power manager according to the system power up or power down command. When the system power up or power down command is received from the central processing unit, the root power manager executes the instructions stored in the memory and transmits power control signals to at least one domain power manager to control power. Accordingly, the system-on-chip device or a subsystem composed of multiple power domains may be powered on or off.

The memory may store a program including instructions and data for domain power up or power down and system power up or power down, and the program stored in the memory may be executed by a domain power manager and/or a root power manager implemented as a programmable sequencer.

Accordingly, it is necessary to design the programmable sequencer to operate as either a domain power manager or a root power manager.

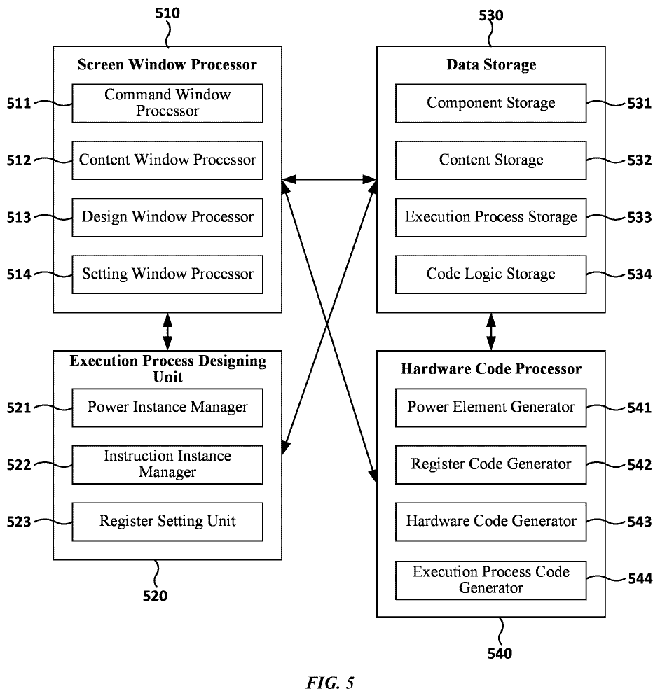

FIG. 5 illustrates a programmable sequencer design system using a no-code approach according to some embodiments of the present disclosure. The programmable sequencer design system of the present disclosure may be a system for designing a microcontroller unit (MCU) to operate as at least one of the root power manager and the domain power manager of FIG. 1, in the form of a programmable sequencer.

The programmable sequencer design system according to the present disclosure includes: a screen window processor 510 configured to detect user input and output processing results of the user input on a display screen; an execution process designing unit 520 configured to generate at least one power instance for configuring a programmable sequencer based on power component information, set a register defining the function of the power instance, and set instructions and data for operating the at least one power instance based on at least one instruction component; a data storage 530 in which code logic is stored for generating register hardware code and binary code of instructions and data based on power component information, instruction component information, and the designed execution process information; and a hardware code processor 540 configured to generate power elements based on the designed power instance information, determine register fields corresponding to the power elements, combine the power elements and the register fields to generate hardware code, and generate binary code of instructions and data for operating the power elements.

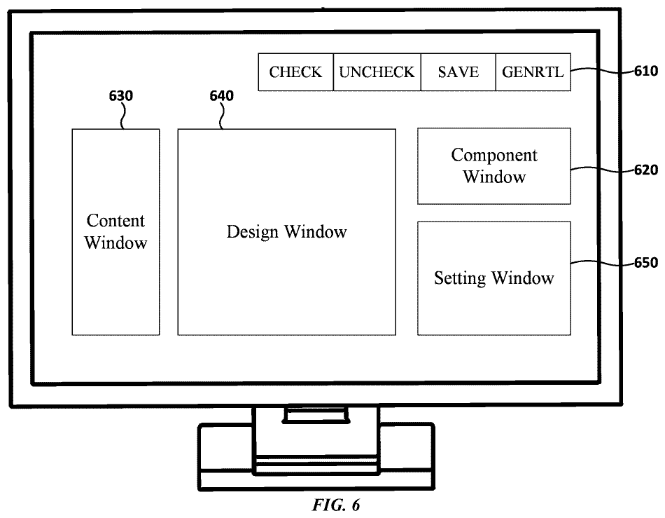

FIG. 6 illustrates an example of a display screen of a programmable sequencer design system using a no-code approach according to some embodiments of the present disclosure.

The display screen of the design system of the present invention may include: a command window 610 for receiving user commands; a component window 620 for displaying power component icons and instruction component icons; a content window 630 that provides an environment for adding, deleting, and modifying a list of power management units under design, and in which each power management unit includes at least one programmable sequencer, with a list of power instances and register information of each power instance hierarchically displayed for any selected programmable sequencer; a design window 640 that allows the addition, deletion, and modification of at least one power instance for configuring a programmable sequencer under design, and also provides an interface for adding, deleting, and modifying instruction instances to define the execution process for power instances; and a setting window 650 that provides an interface for changing the configuration values of power instances selected from the design window 640, and for selecting a power instance and entering a value for the instruction instance.

The command window 610 may include a CHECK button for receiving a command to check for errors in the power management unit, programmable sequencer, and power instances during design; an UNCHECK button for receiving a command to deactivate the check result; a SAVE button for receiving a command to store the power management unit, programmable sequencer, and power instances displayed in the design window 640; and a GENRTL button for receiving a command to generate hardware code for the power instances of the programmable sequencer displayed in the design window 640.

The component window 620 may display a list of power component icons or a list of instruction component icons that may be used for designing the power management unit. When the programmable sequencer to be designed is a domain power manager, the power components may include a reset component for sending a reset signal to the power domain; an isolation component for sending an isolation signal to the power domain; a switch control component for sending a switch control signal to the power domain; a retention component for sending a retention signal to the power domain; an automatic power manager component for automatically executing power up or power down by a trigger signal of hardware; a reference clock gating component for gating a reference clock supplied to the power domain; a memory component for generating a power control signal in a memory of the power domain; a handshake component for generating a handshake control signal with the power domain; a clock link component for generating a link control signal with a clock management unit; a P-channel handshake component for generating a P-channel handshake control signal with the power domain; a user-defined output component for generating a user-defined output signal in the power domain; and a user-defined input component for generating a user-defined input signal in the power domain.

When the programmable sequencer to be designed is a root power manager, the power components that can be utilized in designing the root power manager may include: a component for generating a register used for inform purposes in software; a component for generating a register used for timeout purposes in software; a component for generating a register used for information transfer between upper-level software and the root power manager; a component for storing specific signal values input to the root power manager in internal registers of the root power manager; a component for generating an interrupt by control of the internal registers of the root power manager; a component for generating an interrupt by an external input to an input port of the root power manager; a component for generating an internal timer; and a component for generating a slot for connecting a domain power manager to a lower part of the root power manager.

The instruction components may include a WRITE component for writing a specific value to a specific register field, a READWAIT component for waiting for a specific value to be input to the specific register field, a WAIT component for waiting for a predetermined period of time, an IF component for branching based on a condition, a GOTO component for moving to a specific location, and a CALL component for moving to a specific location and returning thereafter. In addition, the auxiliary instruction components may include a LABEL component, a START component, and an END component. The instruction components and the auxiliary instruction components may each have a unique border shape. For example, the WRITE and READWAIT components may have rectangular borders, the IF component may have a diamond-shaped border, and the LABEL component may have an arrow-shaped border. The LABEL component may be used to connect instruction components and may allow any two or more instruction components that are spaced apart from each other to be substantially connected. At least two LABEL components may be used in the design window, and each LABEL component may be assigned a name and a color for identification.

The design window 640 displays a diagram of a programmable sequencer that constitutes a power management unit during the design process and provides an environment for adding, deleting, and modifying the programmable sequencer.

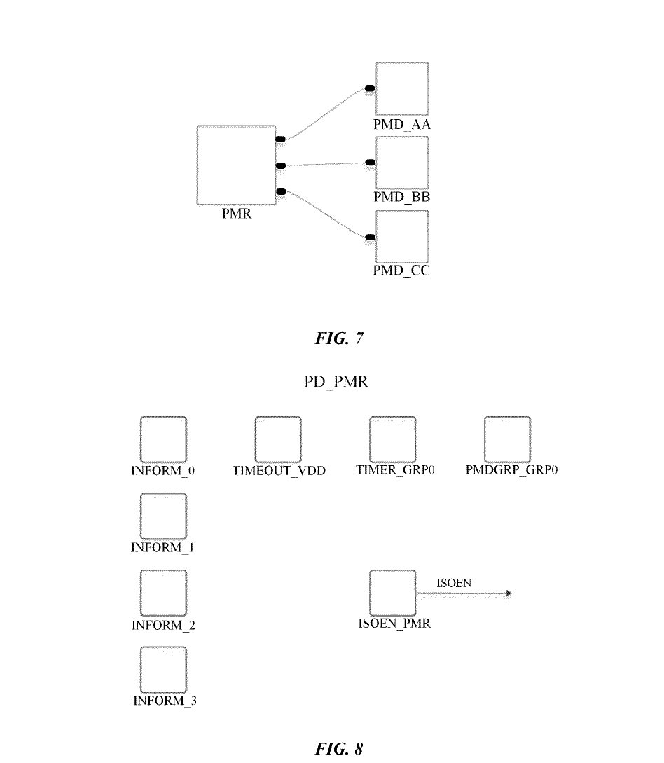

FIG. 7 illustrates an example diagram of a power management unit displayed in the design window. The power management unit may include four programmable sequencers, consisting of one root power manager (PMR) and three domain power managers (PMD_AA, PMD_BB, PMD_CC), although it is not limited thereto.

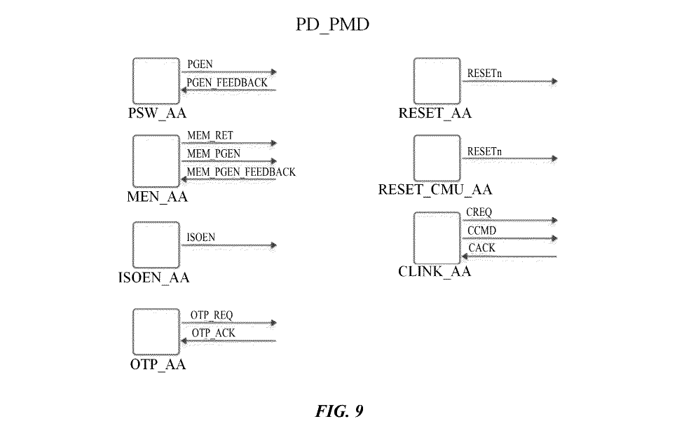

In addition, the design window 640 displays the power instances that constitute the programmable sequencer during design and provides an environment for adding, deleting, and modifying such power instances. FIG. 8 illustrates an example diagram of a root power manager displayed in the design window. The root power manager may include, but is not limited to, eight power instances: four inform instances (INFORM_0, INFORM_1, INFORM_2, INFORM_3), one timeout instance (TIMEOUT_VDD), one timer instance (TIMER_GRPO), one slot generation instance (PMDDGRP_GRPO), and one isolation instance (ISOEN_PMR). FIG. 9 illustrates an example diagram of a domain power manager displayed in the design window. The domain power manager may include, but is not limited to, seven power instances: one switch control instance (PSW_AA), one reset instance (RESET_AA), one isolation instance (ISOEN_AA), one memory instance (MEM_AA), one handshake instance (OTP_AA), one clock link instance (CLINK_AA), and one clock reset instance (RESET_CMU_AA).

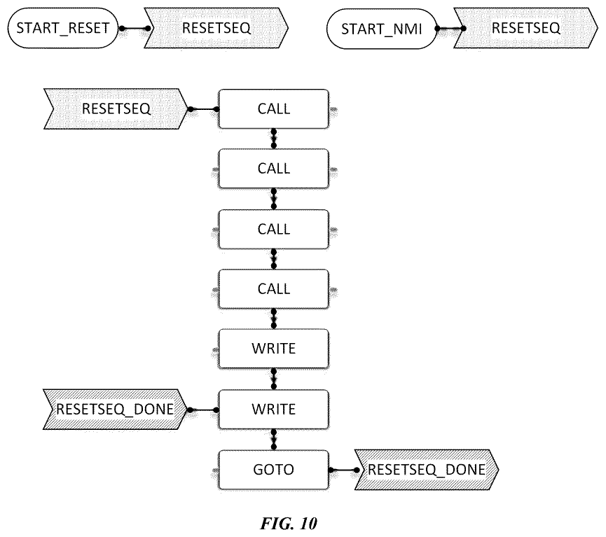

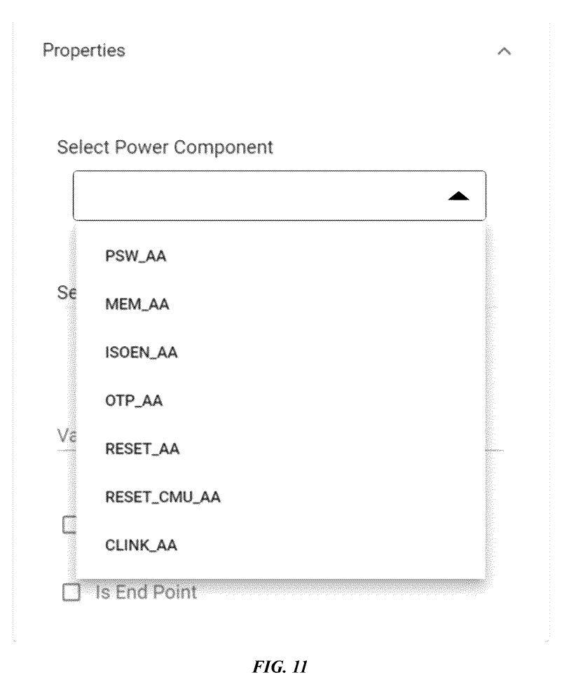

After the design of the power instances of the programmable sequencer is completed, the design window 640 may display an execution process diagram to establish connection relationships between instruction instances. FIG. 10 illustrates an example of an execution process diagram of a programmable sequencer displayed in a design window according to some embodiments of the present disclosure. In the execution process of FIG. 10, two power instances (RESET and NMI) may be set to the same process. Two START instances (START_RESET and START_NMI) and a CALL instance may be substantially connected through a LABEL instance (RESETSEQ). Another instruction instance that is spaced apart may be connected through a LABEL instance linked to the rear end of the CALL instance. In the example shown in FIG. 10, a CALL instance, a WRITE instance, and a GOTO instance are used, but the scope is not limited thereto.

Each instruction instance may be set with a power instance and a value as the execution targets of the instruction. FIG. 11 illustrates an example screen showing the target power instance setting of an arbitrary instruction instance according to some embodiments of the present disclosure. When an instruction instance is added, all power instances included in the corresponding programmable sequencer are displayed so that one power instance can be selected from among all the power instances.

The connection relationship between instruction instances may be indicated by arrows connecting the instruction instances, and such connection relationships may determine the execution order of the instruction instances. The present invention may express and design the execution process of a programmable sequencer in the form of a flowchart.

When a user moves any power component from the component window 620 to the design window 640 by a drag-and-drop operation, a power instance may be added to the programmable sequencer during design, and when the power instance is generated, a new power instance list and register information of the new power instance may be hierarchically added to the content window 630.

The setting window 650 displays a setting value modification environment for a power instance selected from the design window 640, a selection and modification environment of a power instance for an instruction instance selected from the design window 640, and a value input environment.

The screen window processor 510 may include: a command window processor 511, which displays buttons for receiving user commands in the command window 610, detects input for each button, and performs an operation corresponding to the input button; a content window processor 512, which hierarchically displays a list of power management units under design, a list of programmable sequencers included in each power management unit, and a list of power instances and register information included in each programmable sequencer in the content window 630, detects user input in the content window 630, and performs an operation corresponding to the user input; a design window processor 513, which displays a power diagram of the selected power management unit in the design window 640, detects user input in the design window 640, and performs an operation corresponding to the user input; and a setting window processor 514, which displays setting information for a power instance or an instruction instance selected by the user in the setting window 650, detects user input in the setting window 650, and performs an operation corresponding to the user input.

When the CHECK button is selected, the command window processor 511 performs an error checking operation on the diagram of the power management unit under design, the programmable sequencer included in the power management unit under design, the types of power instances included in each programmable sequencer, and their setting values, so that any detected error locations are displayed. When the UNCHECK button is selected, any error indications shown in the diagram of the power management unit under design are restored to their original state. When the SAVE button is selected, the power management unit under design displayed in the design window 640 and its subordinate components are stored in the data storage 530. When the GENRTL button is selected, a hardware code for the programmable sequencer under design displayed in the design window 640 and a binary code of the instructions and data for executing the programmable sequencer are generated.

The content window processor 512 provides an environment for adding, deleting, and modifying the list of power management units under design, the list of programmable sequencers included in each power management unit under design, and the list of power instances included in each programmable sequencer under design. The content window processor 512 displays, under each power management unit under design, the list of programmable sequencers included in that power management unit, and under each programmable sequencer under design, it hierarchically displays the list of power instances included in that programmable sequencer along with the register information of each power instance. Here, a power management unit may include at least one root power manager and at least one domain power manager subordinate to each root power manager. Both the root power manager and the domain power manager may be implemented as programmable sequencers, and accordingly, the power management unit may include a plurality of programmable sequencers.

The user may add, delete, or change the name of a power management unit under design in the content window 630, and the list of power management units under design may be added, deleted, or renamed in the content storage 532 in response to the user's input. When the user changes the name of a power management unit under design, the content window processor 512 may collectively change not only the name of that power management unit but also the names of the programmable sequencers under that unit, the names of the power instances under those sequencers, and the register names of the corresponding power instances.

The design window processor 513 causes the diagram of the power management unit under design to be displayed in the design window 640 and provides an environment for adding, deleting, and modifying the programmable sequencer configuring the power management unit under design. It also causes the diagram of each programmable sequencer to be displayed and provides an environment for adding, deleting, and modifying power instances configuring the programmable sequencer. When the user performs an operation of adding any power component from the component window 620 to the design window 640, the design window processor 513 detects this and executes a power instance addition operation. Additionally, when the user performs an operation of adding any instruction component from the component window 620 to the design window 640, the design window processor 513 detects this and executes an instruction instance addition operation.

The setting window processor 514 allows the setting information of a power instance selected by the user to be displayed in the setting window 650, detects a user input in the setting window 650, and causes an operation corresponding to the user input to be executed. It also allows the setting information of an instruction instance selected by the user to be displayed, detects a user input in the setting window 650, and causes an operation corresponding to the user input to be executed.

The data storage 530 may include: a component storage 531 for storing power component information and instruction component information; a content storage 532 for storing a list of power management units during design, a list of programmable sequencers for each power management unit, a list of power instances for each programmable sequencer, and register information corresponding to the power instances; an execution process storage 533 for storing instruction instances set for the execution process of the programmable sequencer, along with the power instance information and values targeted by each instruction instance; and a code logic storage 534 for storing hardware code logic for generating hardware codes based on the designed power instances and register information, and software code logic for generating binary codes of the execution process for executing the programmable sequencer based on the designed instruction instances. The execution process of the programmable sequencer may include an instruction, a register address, and data.

The power component information stored in the component storage 531 may include an address range allocated for each power component and a register offset size for each individual power component. The power component information defines the register address and field values of power instances generated based on the corresponding power component. The maximum number of power instances for each power component may be calculated using the allocated address range and the register offset size of the individual power component. The allocated address range, the register offset size, and the setting field information may all be differently determined for each power component.

The power component may include at least one of a reset component, an isolation component, a switch control component, a retention component, an automatic power manager component, a reference clock gating component, a memory component, a handshake component, a clock link component, a P-channel handshake component, a user-defined output component, and a user-defined input component.

In addition, the power component may include at least one of: a component for generating a register used for inform purposes in software; a component for generating a register used for timeout purposes in software; a component for generating a register used for information transfer between higher-level software and a root power manager; a component for storing specific signal values input to the root power manager in an internal register of the root power manager; a component for generating an interrupt under the control of an internal register of the root power manager; a component for generating an interrupt under the control of an external input to an input port of the root power manager; a component for generating an internal timer; and a component for generating a slot for connecting a domain power manager to a lower part of the root power manager.

The instruction components stored in the component storage 531 may include: a WRITE component for writing a specific value to a specific register field; a READWAIT component for waiting for a specific value to be input to a specific register field; a WAIT component for waiting for a predetermined time; an IF component for branching according to a condition; a GOTO component for moving to a specific location; and a CALL component for moving to a specific location and allowing return. In addition, the auxiliary instruction components may include a LABEL component, a START component, and an END component. The instruction components and auxiliary instruction components may have unique border shapes. For example, the WRITE component and the READWAIT component may have rectangular borders; the IF component may have a diamond-shaped border; and the LABEL component may have an arrow-shaped border. The LABEL component may be used in connection with instruction components and may enable two arbitrarily spaced instruction components to be substantially connected. Each LABEL component may be assigned a name and a color for identification.

The content storage 532 hierarchically stores a programmable sequencer included in a power management unit during design, as well as power instances included in the programmable sequencer and registers corresponding to each power instance.

The execution process storage 533 stores instruction instances set for the operation of a programmable sequencer, along with execution order information of the instruction instances, and stores, for each instruction instance, the information of the target power instance and the value. When a user drags and drops an instruction component into the design window 640, an instruction instance based on the instruction component is generated. At this time, the target power instance and the value for the instruction instance may be set. In other words, when the instruction component is a WRITE component, it is necessary to set which power instance (e.g., a reset instance or an isolation instance) to write to, and what value (data) to write. The power instance corresponding to the write target is referred to as the target power instance, and the data is referred to as the value. In the present invention, since a register range is predetermined for each power instance, once the target power instance of an instruction instance is determined, the field address of that power instance can also be determined.

In order to design a programmable sequencer to operate from a power up state to a power down state as shown in FIG. 3, the information stored in the execution process storage 533 may include, for example, the following in the order of “instruction instance-target power instance-value”:
WRITE instance—reset instance—0
WRITE instance—isolation instance—1
WRITE instance—switch control instance—1

In order to design a programmable sequencer to operate from a power down state to a power up state, the information stored in the execution process storage 533 may be described, for example, in the order of “instruction instance—target power instance—value” as follows:
WRITE instance—switch control instance—0
WRITE instance—isolation instance—0
WRITE instance—reset instance—1

The instruction instance may be at least one of a WRITE instance based on a WRITE component, a READWAIT instance based on a READWAIT component, a WAIT instance based on a WAIT component, an IF instance based on an IF component, a GOTO instance based on a GOTO component, and a CALL instance based on a CALL component.

The target power instance may be one of at least one power instance constituting the programmable sequencer during design.

The value may be input as a decimal or hexadecimal number.

The code logic storage 534 stores hardware code logic for generating hardware code based on the designed power instances and register information, and stores software code logic for generating binary code comprising instructions, register addresses, and data for executing the programmable sequencer based on the designed instruction instances.

The execution process designing unit 520 may include: a power instance manager 521 that generates a new power instance based on previously generated power instance information and power component information of the same power component, and stores the new power instance in the content storage 532; an instruction instance manager 522 that stores the execution order of at least one or any two instruction instances, and stores the target power instance and value for each instruction instance in the execution process storage 533; and a register setting unit 523 that sets field values of registers that define the functions of the power instances.

The power instance manager 521 may be activated when the user adds a power component from the component window 620 to the design window 640, and may generate a new power instance. The name of the new power instance may include both the name of the programmable sequencer in which it is contained and the type of the corresponding power component. The address of the new power instance may be determined based on the information of the previously generated power instance of the same power component type and the relevant power component information. Specifically, the start address of the register for the new power component may be calculated by adding the start address of the register of the previously generated power instance to the register offset size, and the initial field value of the register may be determined based on the register field information included in the power component information.

The instruction instance manager 522 may configure a connection relationship between at least one instruction instance and other instruction instances according to the execution process of the programmable sequencer. Each instruction instance may include a target power instance and a value. The instruction instance manager 522 may allow a LABEL instance to be added between any two instruction instances. A pair of LABEL instances may be recognized as the same point, and therefore, using a pair of LABEL instances, two instruction instances spaced apart from each other may be configured to be substantially connected. Additionally, a START instance and an END instance may be added to the start and end points of the execution process, respectively, to define the beginning and the end.

The register setting unit 523 may display the field name, bit position, and the like of the register field of a power instance in the design window 640 or the setting window 650, and may allow the user to modify them through input.

The hardware code processor 540 includes a power element generator 541 for generating a power element based on designed power instance information, a register code generator 542 for generating a register code corresponding to the power element, a hardware code generator 543 for generating a hardware code by combining the power element and the register, and an execution process code generator 544 for generating the binary code of the execution process of the programmable sequencer.

The hardware code processor 540 may be executed when the GENRTL button of the command window 610 is selected. The user may select and execute the GENRTL button while a diagram of the power management unit during design is displayed in the design window 640, and may execute the CHECK button before executing the GENRTL button to verify in advance whether there is any error in the diagram.

The power element generator 541 converts the designed power instance information according to the hardware code logic stored in the code logic storage 534 to generate a power element constituting a programmable sequencer. The port type of the power element and the hierarchical structure of the hardware module may be determined according to the settings of the designed power instance.

The register code generator 542 generates a register code of a register bank based on the register field values of the designed power instance in accordance with the hardware code logic, and a port of the register bank corresponding to a port of the power element may be generated.

The hardware code generator 543 automatically connects the corresponding port of the power element and the port of the register bank in accordance with the hardware code logic, and generates the hardware code (RTL code) reflecting the set value of the power instance.

The execution process code generator 544 generates binary code for the execution process based on the software code logic stored in the code logic storage 534. The execution process may include an instruction, a register address, and data. The instruction may be derived from the instruction instance, the register address from the target power instance, and the data from the value.

The generated binary code may be stored in the memory 115, and the processing unit 211 may read the binary code and execute the instruction on the corresponding register bank address, thereby transmitting a power control signal to the power domain.

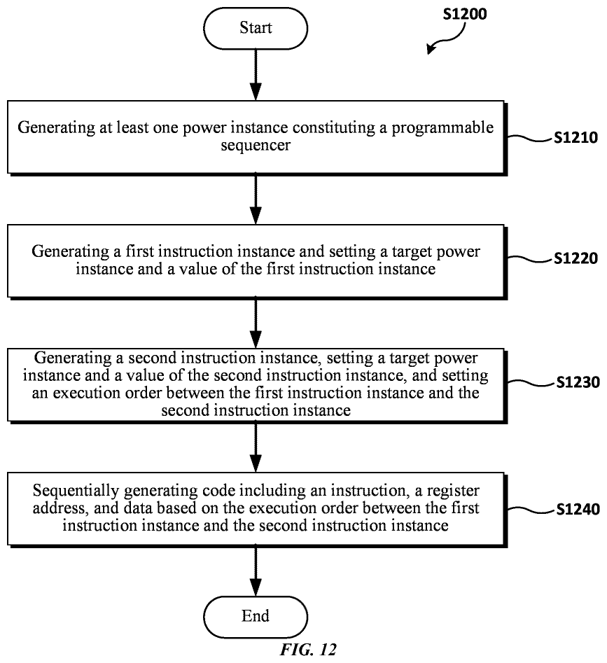

FIG. 12 illustrates an operation flowchart of a method for designing a programmable sequencer using a no-code approach according to some embodiments of the present disclosure. This design method may be executed by a processor of a computer system.

The computer system includes a component store in which power component information and instruction component information are stored, and a code logic store storing software code logic for generating code based on an instruction instance.

The processor generates at least one power instance that constitutes the programmable sequencer (S1210). Step S1210 may be repeatedly executed until all power instances required to configure the programmable sequencer are generated.

The processor generates a first instruction instance based on an instruction component and sets a target power instance and a value for the first instruction instance from among at least one power instance constituting the programmable sequencer (S1220). The target power instance and the value of the first instruction instance may be set through user input.

The processor generates a second instruction instance based on an instruction component, sets a target power instance and a value for the second instruction instance from among at least one power instance constituting the programmable sequencer, and sets the execution order between the first instruction instance and the second instruction instance (S1230). The target power instance and the value of the second instruction instance may be set through user input. In addition, the execution order between the first instruction instance and the second instruction instance may also be set through user input.

The processor sequentially generates code including an instruction, a register address, and data based on the first instruction instance, and code including an instruction, a register address, and data based on the second instruction instance, according to the execution order of the first instruction instance and the second instruction instance (S1240).

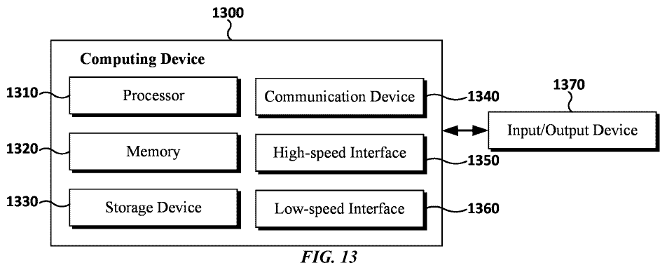

FIG. 13 illustrates an example computing device for performing the above-described methods and/or embodiments according to some embodiments of the present disclosure. According to one embodiment, the computing device 1300 may be implemented using hardware and/or software configured to interact with a user. Here, the computing device 1300 may include, but is not limited to, a laptop, a desktop, a workstation, a personal digital assistant, a server, a blade server, a mainframe, and the like. The components of the computing device 1300, their connections, and their functions are intended to be exemplary and are not intended to limit the implementations of the present disclosure described and/or claimed herein.

The computing device 1300 includes a processor 1310, a memory 1320, a storage device 1330, a communication device 1340, a high-speed interface 1350 connected to the memory 1320 and a high-speed expansion port, and a low-speed interface 1360 connected to a low-speed bus and the storage device. The components 1310, 1320, 1330, 1340, 1350, and 1360 may be interconnected using various buses and may be mounted on the same mainboard or connected in another suitable manner. The processor 1310 may be configured to process instructions of a computer program by performing basic arithmetic, logic, and input/output operations. For example, the processor 1310 may process instructions stored in the memory 1320 and the storage device 1330 and/or instructions executed within the computing device 1300 to display graphical information on an external input/output device 1370, such as a display device connected to the high-speed interface 1350.

The communication device 1340 may provide a configuration or function that enables the input/output device 1370 and the computing device 1300 to communicate with each other through a network and may also provide a configuration or function that supports communication between the input/output device 1370 and/or the computing device 1300 and other external devices. For example, a request or data generated by the processor of an external device according to a given program code may be transmitted to the computing device 1300 through a network under the control of the communication device 1340. Conversely, a control signal or command issued under the control of the processor 1310 of the computing device 1300 may be transmitted to another external device through the communication device 1340 and the network.

Although the computing device 1300 is illustrated in FIG. 13 as including a single processor 1310, a single memory 1320, and the like, the present disclosure is not limited thereto, and the computing device 1300 may be implemented using multiple memories, multiple processors, and/or multiple buses. Additionally, although FIG. 13 describes a single computing device 1300, the present disclosure is not limited thereto, and multiple computing devices may interact and perform the operations necessary to execute the described method.

The memory 1320 may store information within the computing device 1300. In one embodiment, the memory 1320 may be configured as a volatile memory unit or multiple memory units. Additionally or alternatively, the memory 1320 may be configured as a non-volatile memory unit or multiple memory units. Furthermore, the memory 1320 may be configured as a different type of computer-readable medium, such as a magnetic disk or an optical disk. Additionally, the memory 1320 may store an operating system and at least one program code and/or instruction.

The storage device 1330 may be one or more mass storage devices for storing data for the computing device 1300. For example, the storage device 1330 may be a computer-readable medium that includes a magnetic disk such as a hard disk or a removable disk, an optical disk, a semiconductor memory device such as an erasable programmable read-only memory (EPROM), an electrically erasable PROM (EEPROM), or a flash memory device, as well as a CD-ROM and a DVD-ROM disk, or may be configured to include such a computer-readable medium. Additionally, a computer program may be physically implemented in such a computer-readable medium.

The high-speed interface 1350 and the low-speed interface 1360 may serve as means for interacting with the input/output device 1370. For example, an input device may include devices such as a camera with an audio sensor and/or an image sensor, a keyboard, a microphone, and a mouse, while an output device may include devices such as a display, a speaker, and a haptic feedback device. In another example, the high-speed interface 1350 and the low-speed interface 1360 may serve as means for interfacing with a device that integrates both input and output functions, such as a touchscreen.

In one embodiment, the high-speed interface 1350 may manage bandwidth-intensive operations for the computing device 1300, whereas the low-speed interface 1360 may manage operations that are less bandwidth-intensive than those of the high-speed interface 1350, but such a functional allocation is merely exemplary. In one embodiment, the high-speed interface 1350 may be connected to the memory 1320, the input/output devices 1370, and high-speed expansion ports that accommodate various expansion cards (not shown). Additionally, the low-speed interface 1360 may be connected to the storage device 1330 and a low-speed expansion port. Furthermore, the low-speed expansion port, which may include various communication ports (e.g., USB, Bluetooth, Ethernet, and wireless Ethernet), may be connected to one or more input/output devices 1370, such as a keyboard, a pointing device, or a scanner, or to networking devices such as a router or a switch via a network adapter.

The computing device 1300 may be implemented in multiple different forms. For example, it may be implemented as a standard server or as a group of such standard servers. Additionally or alternatively, the computing device 1300 may be implemented as part of a rack server system or as a personal computer, such as a laptop. In this case, components of the computing device 1300 may be integrated with other components within any mobile device (not shown). The computing device 1300 may include one or more other computing devices or may be configured to communicate with one or more other computing devices.

Although the input/output device 1370 is illustrated in FIG. 13 as not being included in the computing device 1300, this is not limiting, and the input/output device 1370 may be configured as a single integrated device with the computing device 1300. Additionally, although the high-speed interface 1350 and/or the low-speed interface 1360 are illustrated in FIG. 13 as components separate from the processor 1310, this is not limiting, and they may be configured to be included in the processor 1310.

The above-described method and/or various embodiments may be realized by digital electronic circuits, computer hardware, firmware, software, and/or a combination thereof. Various embodiments of the present disclosure may be implemented by a data processing device, for example, one or more programmable processors and/or one or more computing devices, or as a computer-readable medium and/or a computer program stored on a computer-readable medium. The computer program described above may be written in any programming language, including compiled or interpreted languages, and may be distributed in any form, such as a standalone program, a module, or a subroutine. The computer program may be distributed through a single computing device, a plurality of computing devices connected through the same network, and/or a plurality of computing devices distributed to be connected through a plurality of different networks.

The above-described method and/or various embodiments may be performed by one or more processors configured to execute one or more computer programs that process, store and/or manage any function and the like by operating based on input data or generating output data. For example, the method and/or various embodiments of the present disclosure may be performed by a special purpose logic circuit such as a field programmable gate array (FPGA) or an application specific integrated circuit (ASIC), and a device and/or a system for performing the method and/or embodiments of the present disclosure may be implemented as special purpose logic circuits such as an FPGA or an ASIC.

The one or more processors executing a computer program may include one or more processors of a general purpose or special purpose microprocessor and/or any kind of digital computing device. The processor may receive instructions and/or data from each of a read-only memory and a random access memory, or may receive instructions and/or data from the read-only memory and the random access memory. In the present disclosure, components of a computing device performing the method and/or embodiments may include one or more processors for executing instructions, and one or more memories for storing instructions and/or data.

In one embodiment, the computing device may transmit/receive data to/from one or more mass storage devices for storing data. For example, the computing device may receive data from a magnetic disc or an optical disc and/or transmit data to the magnetic disc or the optical disc. A computer-readable medium suitable for storing instructions and/or data associated with a computer program may include, but is not limited to, any form of non-volatile memory, including semiconductor memory devices such as an erasable programmable read-only memory (EPROM), an electrically erasable PROM (EEPROM), and a flash memory device. For example, the computer-readable medium may include a magnetic disc, such as an internal hard disk or a removable disk, a photomagnetic disc, a CD-ROM, and a DVD-ROM disk.

To provide interaction with a user, the computing device may include, but is not limited to, a display device (e.g., a cathode ray tube (CRT), a liquid crystal display (LCD), or the like) for providing or displaying information to the user, and a pointing device (e.g., a keyboard, a mouse, a trackball, or the like) for enabling the user to provide input and/or commands to the computing device. That is, the computing device may further include any other types of devices for providing interaction with the user. For example, the computing device may provide any form of sensory feedback to the user, including visual feedback, auditory feedback, and/or tactile feedback, for interacting with the user. In this regard, the user may provide input to the computing device through various gestures, such as vision, voice, and motion.

In the present disclosure, various embodiments may be implemented in a computing device including a back-end component (e.g., a data server), a middleware component (e.g., an application server), and/or a front-end component. In this case, the components may be interconnected by any form or medium of digital data communication, such as a communication network. In one embodiment, the communication network may include a wired network such as Ethernet, a power line communication), a telephone line communication device, and RS-serial communication, a wireless network such as a mobile communication network, a wireless LAN (WLAN), Wi-Fi, Bluetooth, and ZigBee, or a combination thereof. For example, the communication network may include a local area network (LAN), a wide area network (WAN), or the like.

The computing device based on the exemplary embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include, but is not limited to, a personal digital assistant (PDA), a tablet PC, a game console, a wearable device, an Internet-of-Things (IoT) device, a virtual reality (VR) device, an augmented reality (AR) device, and the like. The computing device may further include other types of devices configured to interact with a user. Furthermore, the computing device may include a portable communication device (e.g., a mobile phone, a smartphone, a wireless cellular phone, and the like) suitable for wireless communication over a network, such as a mobile communication network. The computing device may be configured to wirelessly communicate with a network server using wireless communication technologies such as Radio Frequency (RF), Microwave Frequency (MWF), and/or Infrared Ray Frequency (IRF) and/or protocols.

Various embodiments including specific structural and functional details in the present disclosure are exemplary. Therefore, the embodiments of the present disclosure are not limited to those described above, and may be implemented in various other forms. In addition, the terms used in the present disclosure are intended to describe some embodiments and are not to be construed as limiting the embodiments. For example, singular words and the above may be construed to include plural forms unless the context clearly indicates otherwise.

In the present disclosure, unless otherwise defined, all terms used in this specification, including technical or scientific terms, have the same meaning as commonly understood by a person skilled in the art to which such concepts belong. In addition, commonly used terms, such as terms defined in the dictionary, should be interpreted as having a meaning consistent with the meaning in the context of the relevant technology.

Although the present disclosure has been described in connection with some embodiments herein, various modifications and changes may be made without departing from the scope of the present disclosure as understood by a person skilled in the art to which the present disclosure belongs. In addition, such modifications and changes should be considered to fall within the scope of the claims appended hereto.

What is claimed is:

1. A system for designing a programmable sequencer in a no-code approach, comprising:
a memory configured to store at least one instruction;
a component storage configured to store power component information and instruction component information;
a code logic storage configured to store software code logic for generating a code based on an instruction instance; and
at least one processor configured to execute the at least one instruction stored in the memory,
wherein the at least one instruction includes instructions for:
generating at least one power instance configuring a programmable sequencer based on a power component;
generating a first instruction instance based on an instruction component;
determining a target power instance of the first instruction instance among one or more power instances and setting a value; and
generating a code including an instruction, a register address, and data based on the first instruction instance, the target power instance, and the value.

2. The system of claim 1, wherein the programmable sequencer is at least one of a root power manager and a domain power manager.

3. The system of claim 1, The system of claim 1, wherein the at least one instruction includes instructions for:
generating a second instruction instance based on an instruction component;
determining a target power instance of the second instruction instance from among one or more power instances and setting a value; and
setting an execution order between the first instruction instance and the second instruction instance.

4. The system of claim 2, wherein the power component is at least one of a reset component, an isolation component, a switch control component, a retention component, an automatic power manager component, a reference clock gating component, a memory component, a handshake component, a clock link component, a P-channel handshake component, a user-defined output component, or a user-defined input component.

5. The system of claim 2, wherein the power component is at least one of an inform register generation component, a timeout register generation component, an upper information transfer register generation component, an internal register storage component, an internal register control interrupt generation component, an external input control interrupt generation component, a timer generation component, or a domain power manager connection component.

6. The system of claim 1, wherein the instruction component is at least one of a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, or a CALL component for moving to a specific location and returning.

7. The system of claim 6, wherein the component storage further stores an auxiliary instruction component, and the auxiliary instruction component includes at least one of a LABEL component, a START component, or an END component.

8. The system of claim 7, the instruction component and the auxiliary instruction component include a unique border shape.

9. The system of claim 7, wherein the LABEL component allows any two or more instruction components that are spaced apart to be substantially connected, and at least one of a name and a color is assigned to the LABEL component for identification.

10. A method for designing a programmable sequencer using a no-code approach, executed by at least one processor in a computer system including a component storage storing power component information and instruction component information, and a code logic storage storing software code logic for generating code based on an instruction instance, the method comprising:
(i) generating at least one power instance configuring a programmable sequencer based on a power component;
(ii) generating a first instruction instance based on an instruction component;
(iii) determining a target power instance of the first instruction instance from among one or more power instances and setting a value; and
(iv) generating a code including an instruction, a register address, and data based on the first instruction instance, the target power instance, and the value.

11. The method of claim 10, wherein the programmable sequencer is at least one of a root power manager and a domain power manager.

12. The method of claim 10, further comprising:
generating a second instruction instance based on an instruction component;
determining a target power instance of the second instruction instance from among one or more power instances and setting a value; and
setting an execution order between the first instruction instance and the second instruction instance.

13. The method of claim 11, wherein the power component is at least one of a reset component, an isolation component, a switch control component, a retention component, an automatic power manager component, a reference clock gating component, a memory component, a handshake component, a clock link component, a P-channel handshake component, a user-defined output component, or a user-defined input component.

14. The method of claim 11, wherein the power component is at least one of an inform register generation component, a timeout register generation component, an upper information transfer register generation component, an internal register storage component, an internal register control interrupt generation component, an external input control interrupt generation component, a timer generation component, or a domain power manager connection component.

15. The method of claim 10, wherein the instruction component is at least one of a WRITE component for writing a specific value to a specific register field, a READWAIT component for waiting for a specific value to be input to a specific register field, a WAIT component for waiting for a certain period of time, an IF component for branching according to a condition, a GOTO component for moving to a specific location, or a CALL component for moving to a specific location and returning.

16. The method of claim 15, wherein the component storage further stores an auxiliary instruction component, and the auxiliary instruction component includes at least one of a LABEL component, a START component, or an END component.

17. The method of claim 16, wherein the instruction component and the auxiliary instruction component include a unique border shape.

18. The method of claim 17, wherein the LABEL component allows any two or more instruction components that are spaced apart to be substantially connected, and at least one of a name and a color is assigned to the LABEL component for identification.

19. A computer program stored on a computer-readable medium for causing a computer to execute a method according to claim 10.
